(19) United States
(12) Patent Application Publication
(10) Pub. No.: US 2012/0323785 A1
(43) Pub. Date: Dec. 20, 2012

(54) METHOD OF USING PAPER CHECKS THAT ARE TIED TO PREPAID DEBIT CARD AND CASHED ONLY BY DESIGNATED ENTITIES

(76) Inventors: Richard J. ELLIOT, Escondido, CA (US); Joseph M. PURCELL, Laguna Niguel, CA (US)

(21) Appl. No.: 13/450,632

(22) Filed: Apr. 19, 2012

Related U.S. Application Data
(60) Provisional application No. 61/497,299, filed on Jun. 15, 2011.

(51) Int. Cl. G06Q 20/40

(52) U.S. Cl. 705/44

(57) ABSTRACT

A method is provided of using paper checks to debit funds maintained in a debit card bank account that is associated with a person. A plurality of unique serial numbers are assigned by the debit card issuer to be pre-printed on paper checks that are associated with the debit card bank account number. The unique serial numbers have no relationship to any personally identifiable information associated with the person. When a filled in paper check is presented for cashing, the unique serial number is checked against the originally assigned serial numbers to verify that the paper check is genuine. Identification information of the person is also verified, and the account balance of the debit card bank account is also verified to make sure that there are sufficient funds in the bank account to cover the check amount.

### CROSS-REFERENCE TO RELATED APPLICATIONS

This application claims priority to U.S. Provisional Patent Application No. 61/497,299 filed Jun. 15, 2011, which is incorporated herein by reference.

### BACKGROUND OF THE INVENTION

Global Cash Card (GCC) is a Prepaid Card Issuer. Global Cash Card's clients include employers and other business entities. These companies may be employers who issue cards to W-2 and 1099 employees for the purpose of loading financial compensation to which the cardholder is entitled. When a card is loaded, the cardholder has several methods for retrieving their funds. Among these methods are ATM withdrawal, cash advance, POS (point of sale) and the GCheck.

A GCheck (also, referred to herein as a “G-Check”) allows cardholders to receive a specified amount cash to-the-penny without incurring any third party merchant fees. The cardholder receives cash from their Global Cash Card account by writing a GCheck for a desired amount, equal to or less than their available Global Cash Card balance.

The cardholder receives blank GChecks via one of two methods. The cardholder may request blank GChecks directly from Global Cash Card customer service. Or, employers may request blank GChecks on behalf of employees to be included in the Cardholder Welcome Kits. All GChecks contain blank fields for an authorization code and issuer ID. The check does not become assigned to a cardholder and usable until the cardholder specifies a check amount and receives an authorization code from Global Cash Card customer service and written on the GCheck in the provided fields.

Global Cash Card maintains a direct relationship with one or more retailers (designated retailers), such as Walmart® Stores. GChecks can be used at any establishment that is willing to accept the GCheck or designated retailer via the method described below.

Global Cash Card maintains a direct relationship with one or more check verification providers, such as Certegy®.

When a cardholder wishes to utilize a GCheck, the following steps are performed:

1. The cardholder calls Global Cash Card customer service and requests the use of a GCheck for a specified amount.

2. The Global Cash Card customer service specialist validates the identity of the cardholder and checks the cardholder's available balance.

3. Upon successful validation of identity and available balance equal to or greater than the specified GCheck amount, the Global Cash Card customer service specialist issues an authorization code to the cardholder.

4. The cardholder account is debited for the authorized amount.

5. The cardholder writes the authorization code on the GCheck along with an amount equal to or less than the authorized GCheck amount.

6. The cardholder goes to one of the designated or willing retailers.

7. The cardholder presents the completed GCheck to the retailer along with their photo ID and if the retailer is a “Designated retailer,” also provides a Social Security Number.

8. If the retailer is a “Designated retailer”, the information is then electronically forwarded to the designated check verification provider.

9. If the retailer is a “Designated retailer”, the check verification provider sends an online request to Global Cash Card containing the MICR, check amount and last four digits of the Social Security Number.

10. If the retailer is a “Designated retailer” and if the last four digits of the social security number match the correct cardholder record in the Global Cash Card database, and the check amount is less than or equal to the authorized amount, Global Cash Card will send back an approval to the check verification provider. The check verification provider then forwards the approval to the retailer. The retailer then provides the approved amount of cash to the cardholder

11. If the retailer is a “Designated retailer” and if a match is unsuccessful, Global Cash Card will return a decline response back to the check verification provider. The decline will then be forwarded to the retailer

12. If the retailer is NOT a “Designated Retailer”, the retailer calls Global Cash Card customer service for verbal check verification.

13. Global Cash Card logs each verification attempt and change of status of GChecks

Global Cash Card accounting personnel performs reconciliation of the GCheck process as follows:

1. The accounting employee accesses the GCheck Clearing account cash management interface.

2. A list of presented GChecks is downloaded.

3. The authorization code and amount of each presented GCheck is validated against a list of GCheck approvals performed at designated retailers and issued authorization codes. If the presented item matches a previous GCheck approval or authorization code, the check is allowed to clear. If the item does not match, the GCheck is rejected and returned unpaid.

The process described above requires the cardholder to perform two request steps before a GCheck can be cashed. First, the cardholder must contact GCC (steps 1-3). Second the cardholder must present the check to the cashing entity (steps 6-10 or step 12). The process described above also requires that the cardholder obtain an authorization code and write it on the GCheck so that the check will be allowed to clear. There is a need for a simpler process that does not require two request steps to cash a GCheck and that does not require the use of an authorization code that must be obtained by the cardholder. The present invention fulfills such a need.

### BRIEF SUMMARY OF THE INVENTION

A method is provided of using paper checks to debit funds maintained in a debit card bank account that is associated with a person. A plurality of unique serial numbers are assigned by the debit card issuer to be pre-printed on paper checks that are associated with the debit card bank account number. The unique serial numbers have no relationship to any personally identifiable information associated with the person. When a filled in paper check is presented for cashing, the unique serial number is checked against the originally assigned serial numbers to verify that the paper check is genuine. Identification information of the person is also verified, and the account balance of the debit card bank account is also verified to make sure that there are sufficient funds in the bank account to cover the check amount.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. However, the invention is not limited to the precise arrangements and instrumentalities shown.

In the drawings:

FIGS. 1-2 and 4-8 show user interface display screens in accordance with one preferred embodiment of the present invention.

FIG. 3 shows a sample GCheck in accordance with one preferred embodiment of the present invention.

FIGS. 9 and 10 are flowcharts in accordance with two different views of a preferred embodiment of the present invention.

FIG. 11 is an overview of the GCheck data schema in accordance with one preferred embodiment of the present invention.

FIG. 12 is a schematic block diagram of the hardware/software components of one preferred embodiment of the present invention.

### DETAILED DESCRIPTION OF THE INVENTION

Certain terminology is used herein for convenience only and is not to be taken as a limitation on the present invention.

### I. Overview

The present invention is described in the context of an alternative payment process developed by Global Cash Card located in Irvine, Calif. The alternative payment process allows paper checks to be used in conjunction with a debit card (also known as a bank card or check card) accounts. The paper checks are referred to as GChecks, and individually as a GCheck™. Global Cash Card is also referred to herein as “GCC.” This alternative process (described below) does not require two request steps to cash a GCheck and does not require the use of an authorization code that must be obtained by the cardholder.

The following entities are involved in a GCheck transaction:

1. cardholder (also, referred to as the “Global Cash Card cardholder”): This is the person who has a debit card account. The debit card is loaded with earned financial compensation when the person is paid by an employer or contractor, such as when the employer's payroll is processed. The cardholder is also the entity that presents GChecks to be cashed that are tied to the debit card account.

2. designated retailer (also, referred to as “authorized merchant”): This is an entity that is authorized to cash GChecks. In one preferred embodiment of the present invention described herein, the designated retailer is Walmart®. There are preferably many different designated retailers. The retailer location or merchant location is the physical location that the cardholder goes to cash the checks.

3. check authorization/verification service provider: This is the entity that the designated retailer contacts before cashing a GCheck. This entity has real-time access to bank accounts, including the debit card accounts of the cardholder, and can verify balances in such accounts in real-time. In one preferred embodiment of the present invention described herein, the check authorization/verification service provider is Certegy® (Certegy Check Services, Inc., Tampa, Fla.) The designated retailer and Global Cash both have an established relationship with the check authorization/verification service provider so that the designated retailer may contact the service provider when a check is presented for cashing by a cardholder.

4. settlement bank: This is the bank that the designated retailer uses to clear GChecks that the retailer has cashed. In one preferred embodiment of the present invention described herein, the settlement bank is First Regional Bank®.

The GCheck process enables Global Cash Card cardholders to obtain their pay from their cardholder account to the penny without incurring any fees. A cardholder receives payroll on their paycard and may elect to access these funds with a paper check or GCheck. Global Cash Card has established a Positive Pay Partnership with Certegy to offer cardholders more than 11,000 merchant locations to cash a G-check with ease and security. Global Cash Card has an established relationship with Walmart, which is a Certegy merchant, to ensure that cardholders are not charged any merchant fees for cashing checks.

Walmart invoices Global Cash Card on a monthly basis for fee reimbursement. The partnership controls fraud by limiting the checks cashed on accounts, thus controlling fraud.

G-Checks are sent to cardholders after Global Cash Card registers each check number in the system to the particular cardholder's account. The cardholder elects to disburse funds from their Global Cash Card account by writing the check for the amount desired, equal to or less than their available balance. The cardholder goes to a Walmart location with in-house money services with the completed check and picture ID. A Walmart cashier collects the picture ID. The cardholder provides their Social Security number through PIN pad. The cashier runs the check through a Point of Service (POS) terminal which queries Certegy's positive pay system. Certegy queries the Global Cash Card system for a response. The Global Cash Card system returns a positive response if the last four of the SSN, check number, account number, match and the cardholder available balance is enough to cover check amount. The cardholder account is then successfully debited. The Walmart cashier provides funds to the cardholder and the POS suppresses their merchant fee to the cardholder.

Walmart then invoices GCC monthly $3.00 for each GCheck cashed in their stores.

Walmart settles the check with First Regional Bank. GCC Accounting reconciles settlement account with First Regional against cardholder accounts.

### II. Detailed Disclosure

Global Cash Card is a Prepaid Card Issuer. Global Cash Card's clients include employers and other business entities. These companies may be employers who issue cards to W-2 and 1099 employees for the purpose of loading financial compensation to which the cardholder is entitled. When a card is loaded, the cardholder has several methods for retrieving their funds. Among these methods are ATM withdrawal, cash advance, POS (point of sale) and the GCheck.

A GCheck allows cardholders to receive a specified amount cash to-the-penny without incurring any third party merchant fees. The cardholder receives cash from their Global Cash Card account by writing a GCheck for a desired amount, equal to or less than their available Global Cash Card balance.

### 1. Fulfillment:

The cardholder receives blank GChecks via one of two methods. The cardholder may request blank GChecks directly from Global Cash Card customer service. Or, employers may request blank GChecks on behalf of employees to be included in the Cardholder Welcome Kits.

Each GCheck has a unique serial number that is printed on the check and included on the check MICR. When blank GChecks are issued to a cardholder, the serial number on the GCheck is assigned directly to the cardholder record via a direct relationship in the Global Cash Card database.

### 2. Utilization of GChecks:

Global Cash Card maintains a direct relationship with one or more retailers (designated retailers) including Walmart Stores. GChecks can only be used at a designated retailer via the method described below.

Global Cash Card maintains a direct relationship with one or more check verification providers. These check verification providers include Certegy.

When a cardholder wishes to utilize a GCheck, the following steps are performed:

i. The cardholder goes to one of the designated retailers.

ii. The cardholder enters the desired withdrawal amount onto the previously supplied GCheck.

iii. The cardholder presents the completed GCheck to the retailer along with their photo ID and Social Security Number.

iv. This information is then electronically forwarded to the designated check verification service provider.

v. The check verification service provider sends an online request to Global Cash Card containing the MICR, check amount and last four digits of the Social Security Number.

vi. If the check serial number (contained in the MICR) and last four digits of the social security number match the correct cardholder record in the Global Cash Card database, and the check amount is less than or equal to the cardholder balance, Global Cash Card will debit the account and send back an approval to the check verification provider. The check verification provider then forwards the approval to the retailer. The retailer then provides the approved amount of cash to the cardholder.

vii. If a match or balance check is unsuccessful, Global Cash Card will return a decline response back to the check verification provider. The decline will then be forwarded to the retailer.

In an alternative embodiment, all of the digits of the Social Security Number are entered and used in the verification process.

### 3. Reconciliation:

Global Cash Card accounting personnel performs reconciliation of the GCheck process in the following manner:

i. The accounting employee accesses the GCheck Clearing account cash management interface.

ii. A list of presented GChecks is downloaded

iii. The serial number and amount of each presented GCheck is validated against a list of GCheck approvals performed at designated retailers. If the presented item matches a previous GCheck approval, the check is allowed to clear. If the item does not match, the GCheck is rejected and returned unpaid.

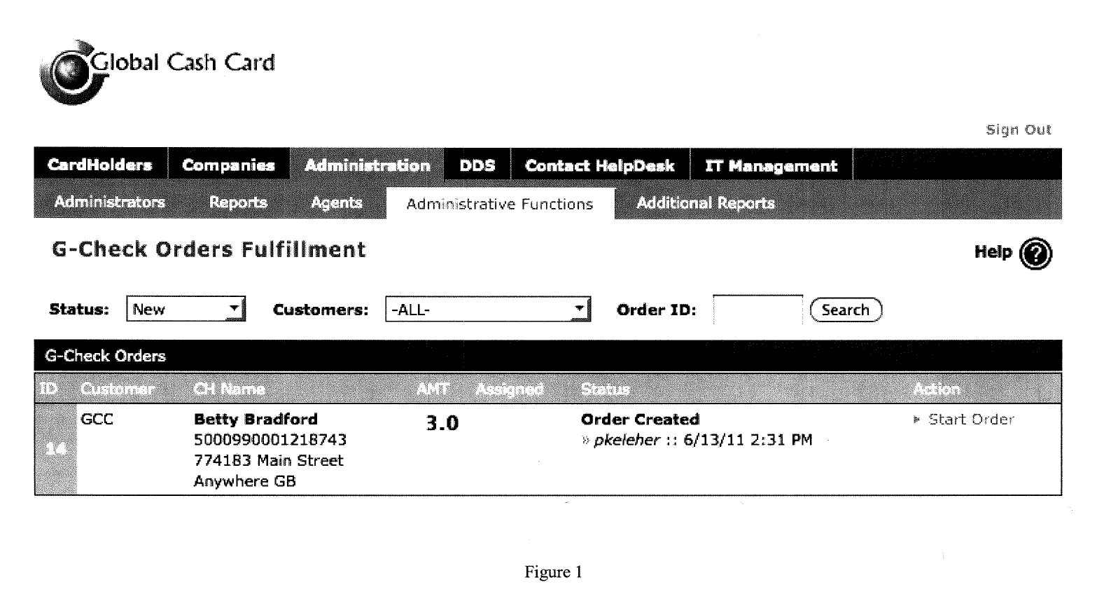

FIGS. 1-8 show user interface display screens and Tables 1-6 shows corresponding data attributes for check fulfillment, check presentment, check settlement, check reconciliation, and fee reconciliation, in accordance with one preferred embodiment of the present invention. These figures and tables are self-explanatory.

### 1. Check Fulfillment

GCC will fulfill an order for G-Checks to assign checks to a cardholder.

TABLE 1

| | |
|---|---|
| 1 | Global Cash Card |
| | Employee Name |
| | User ID |

FIG. 1 shows a user interface display screen associated with the order fulfillment process.

Cardholder Account registers all G-Checks associated to that account.

TABLE 2

| | |
|---|---|
| 2 | G Check |
| | G.Check Number |
| | F.Account Number |
| | F.Routing Number |
| | G.Amount |
| | G.Status |

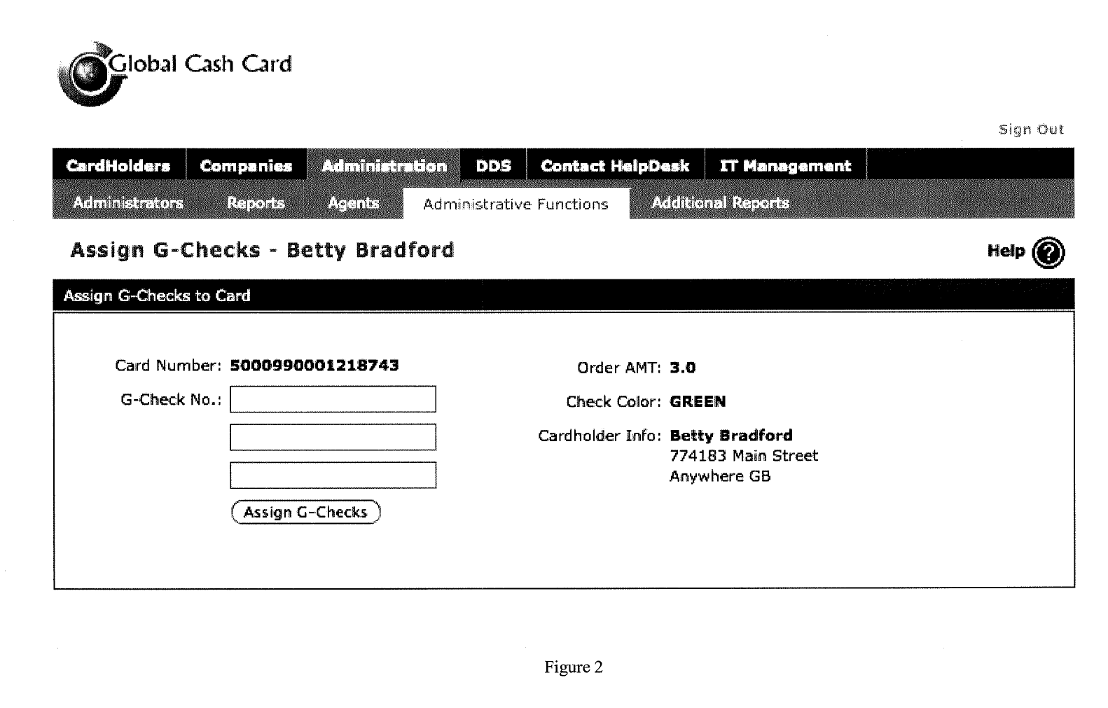

FIG. 2 shows a user interface display screen associated with the check registration process.

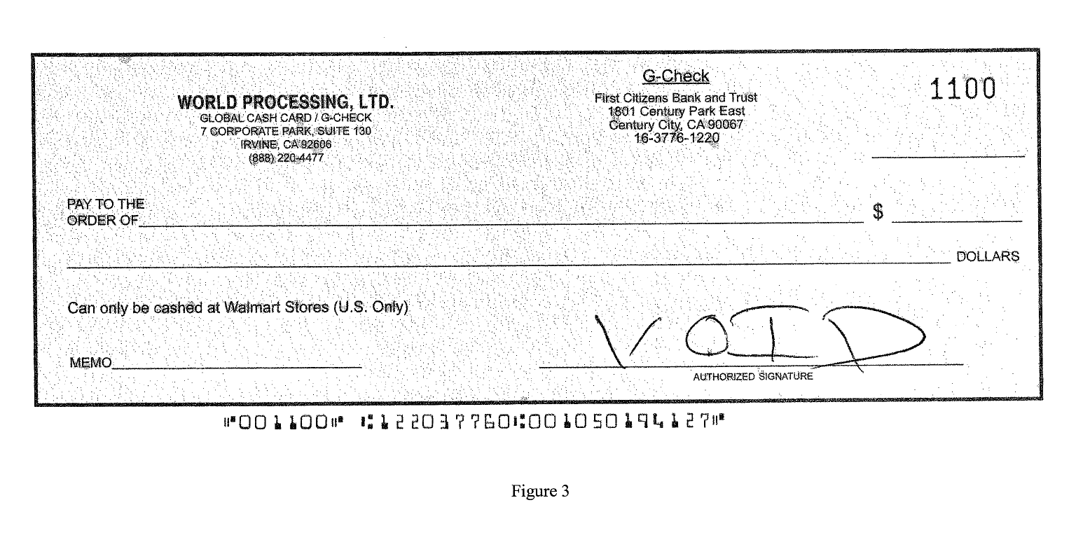

FIG. 3 shows a sample GCheck.

TABLE 3

| | |
|---|---|
| 3 | Cardholder |
| | CH.Cardnumber |
| | CH.SSN |
| | CH.USMailing Address |
| | CH.Picture ID |
| | CH.$Funds |

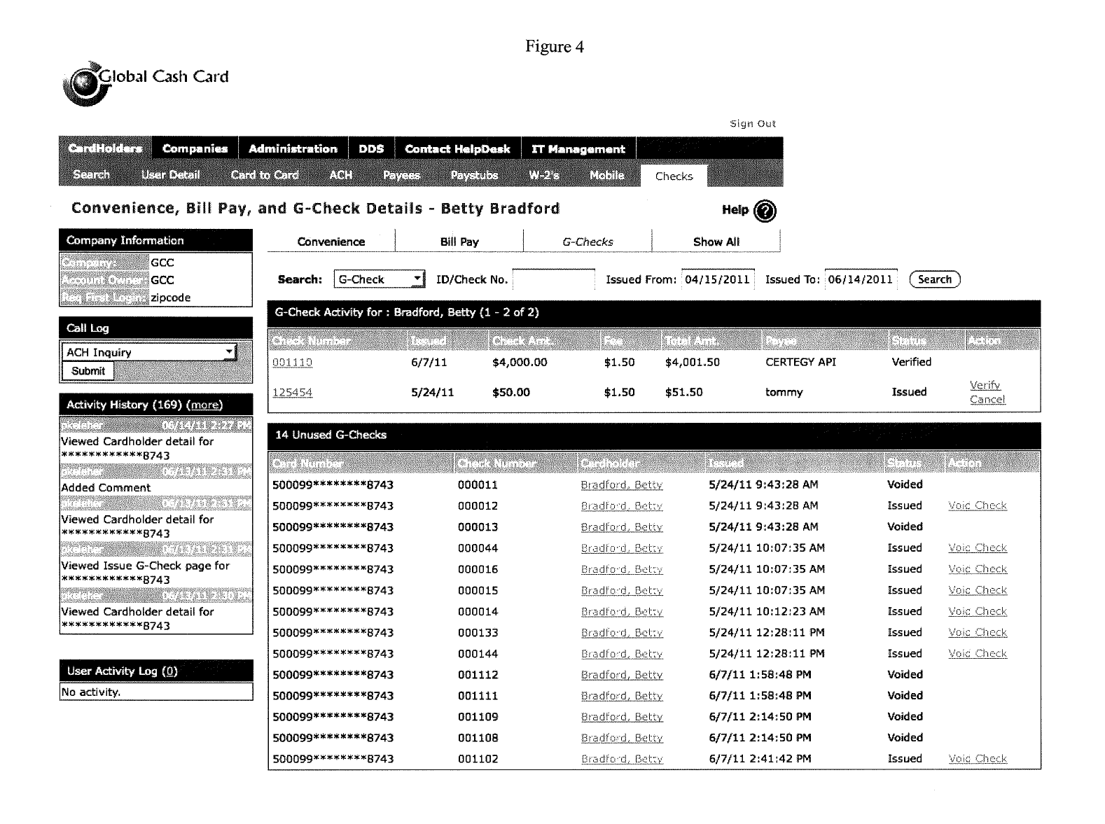

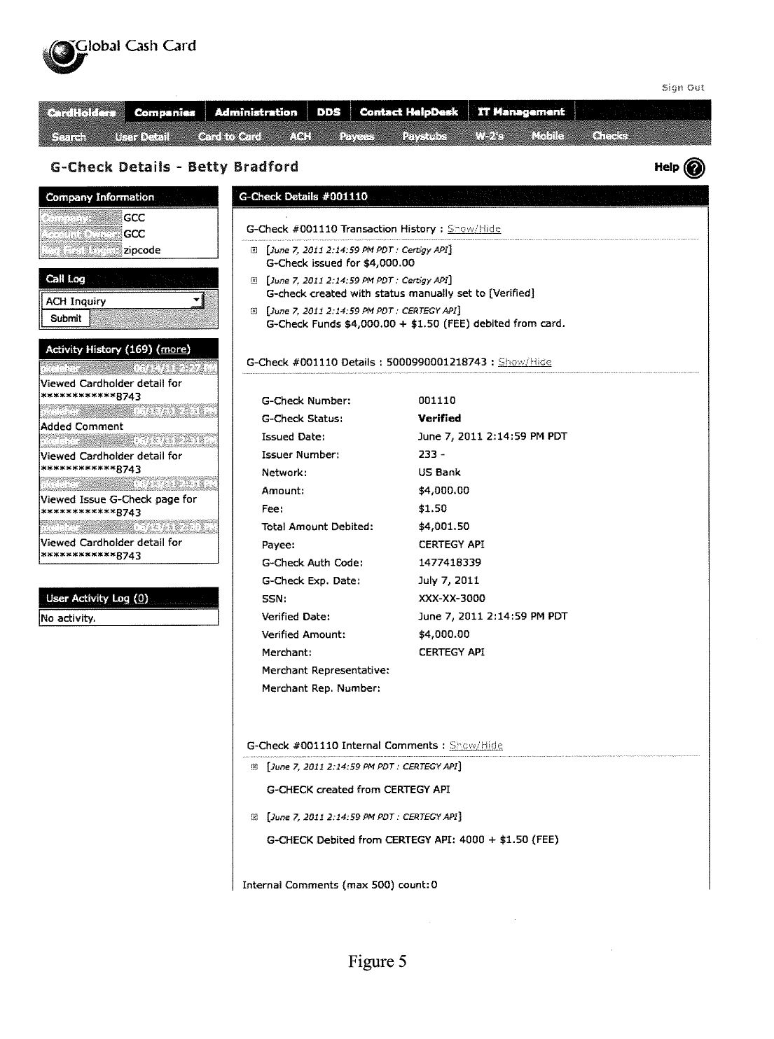

GCC logs a detailed transaction history for each G-Check. FIG. 4 shows a user interface display screen of sample of the log. FIG. 5 shows a user interface display screen of the transaction history details of one particular GCheck.

### 2. Check Presentment

Walmart POS sends information to Certegy who queries our system for a response.

TABLE 4

| | |
|---|---|
| 4 | Wal Mart |
| | G.Check Number |
| | G.AccountNumber |
| | G.Amount |
| | C.Picture ID |
| | CH.Funds |
| | Ce.ResponseCode |
| | W.MerchantFee |

Certegy sends back a successful response code that check is OK to cash if the ssn, check number, account number and cardholder balance are equal or less than the check amount.

### Certegy

TABLE 5

| | |
|---|---|
| 5 | Certegy |
| | G.Check Number |
| | G.AccountNumber |
| | G.Amount |
| | C.Picture ID |
| | CH.Funds |
| | Ce.ResponseCode |

| RESPONSE KEY | CODE |
|---|---|
| No problems reported. | 00 |
| Check already cleared. | 10 |
| Check has been voided. | 20 |
| Check already verified once. It is up to the cashier | 30 |
| to go ahead and cash it or not. Some customers may | |
| verify their own checks before they try to cash it. | |
| Check number is not valid or does not exist. | 40 |
| SSN is not valid. | 50 |
| Check amount does not match our records. | 60 |
| Username or password incorrect. | 70 |
| SSN is valid but not associated with a participating | 80 |
| Bank product. | |
| System Down. | 90 |

### 3. Check Settlement

Walmart presents check to First Regional Bank for settlement.

TABLE 6

| | |
|---|---|
| 6 | First Regional Bank |
| | F.AccountNumber |
| | F.Routing Number |
| | G.Check Number |
| | G.Amount |

### 4. Check Reconciliation

Global Cash Card Accounting verifies cleared checks with First Regional Account. Status is changed to Cleared. Accounting may also Void and Cancel checks.

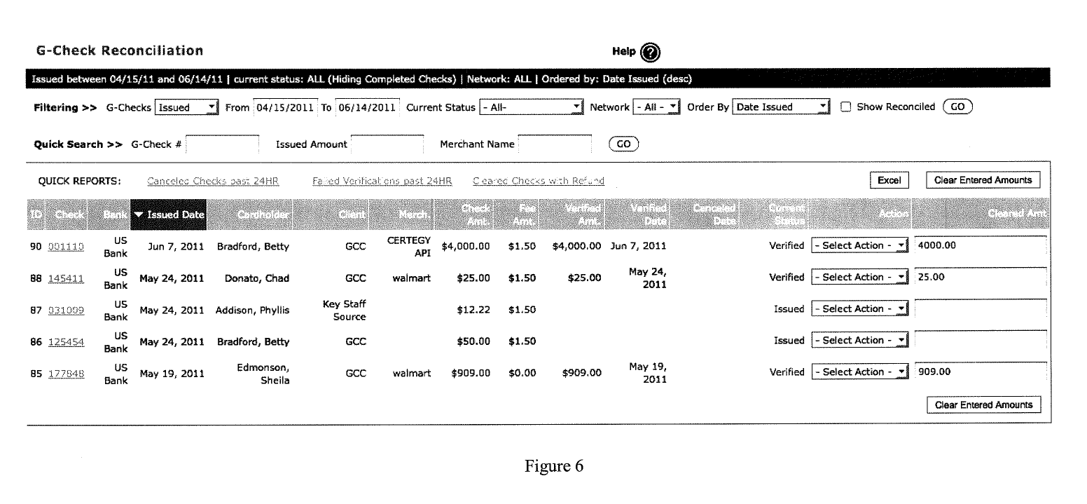

FIG. 6 shows a user interface display screen associated with check reconciliation.

### 5. Fee Reconciliation

Walmart provides Global Cash Card with a monthly invoice file to reimburse fees.

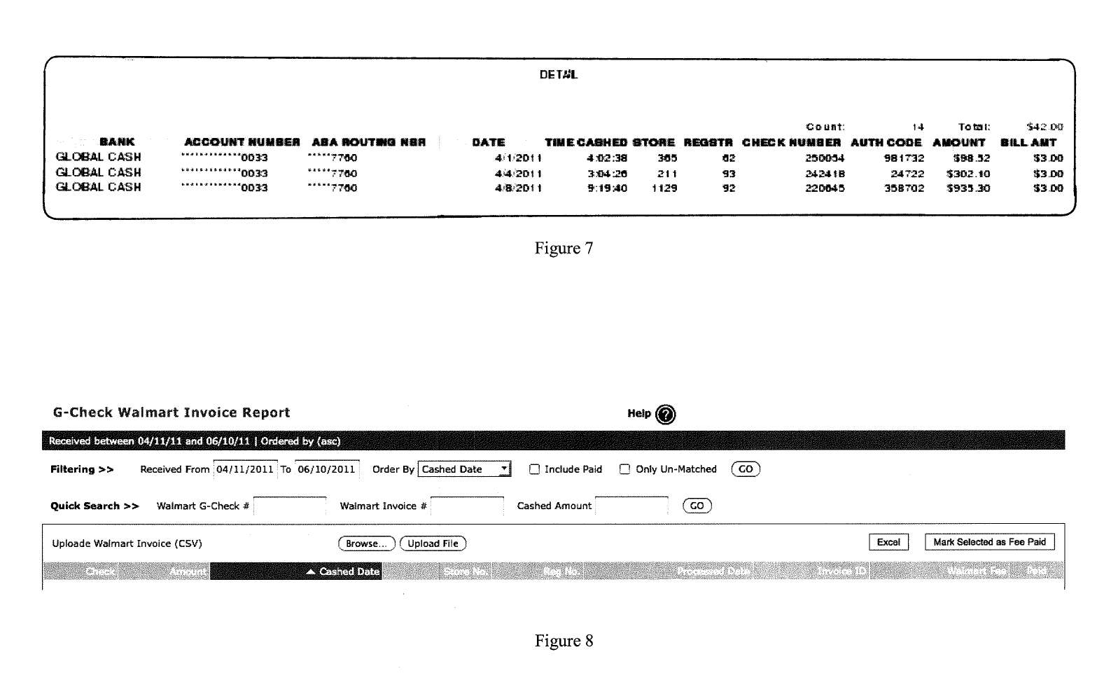

FIG. 7 shows a user interface display screen that provides details of the fee reconciliation. The file is then recorded. FIG. 8 shows a user interface display screen for a GCheck Walmart invoice report.

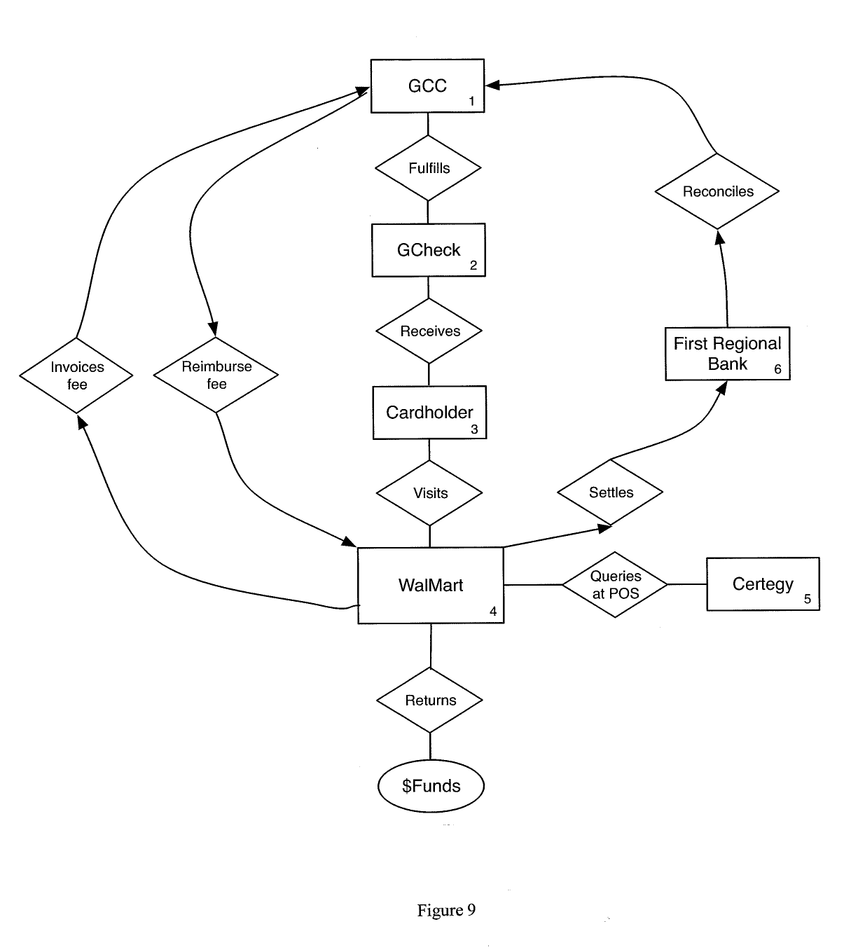

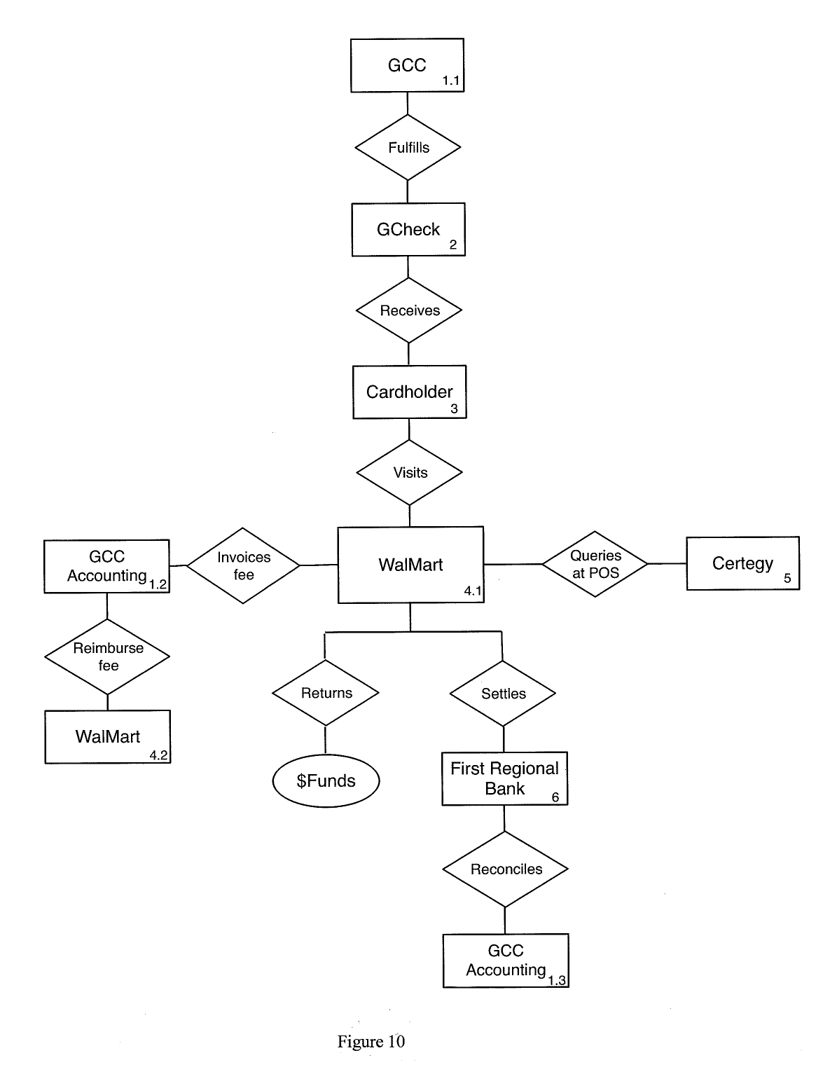

FIGS. 9 and 10 are self-explanatory flowcharts in accordance with two different views of a preferred embodiment of the present invention. In FIG. 9, the settlement, fee and reconciliation elements are shown, whereas in FIG. 10, these elements are not shown. The numbers 1-6 in these figures correspond to the Tables 1-6 described above.

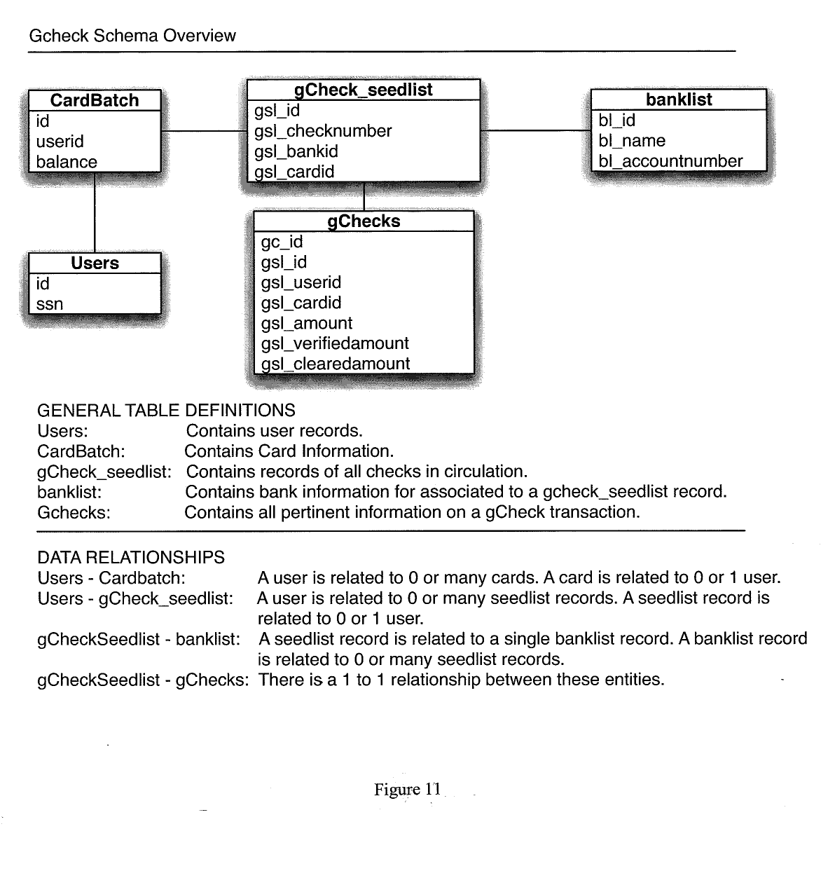

FIG. 11 is a self-explanatory overview of the GCheck data schema, and shows table definitions and data relationships. Referring to FIG. 11, the following explanation is a functional overview of a generic GCheck lifecycle:

i. A gCheck first enters the system as a gCheck_seedlist record. It is associated to the issuing bank (banklist) and a card (cardbatch).

ii. Once a card is assigned to a user, the associated seedlist records are updated with the user's ID.

iii. Once a seedlist record has been assigned to a user, that record (physical check) is available to be used by that user.

iv. Once a physical check is handed to a third-party vendor, the system will verify the request using information from the seedlist-card-user relationship to verify the account, available funds, and merchant.

v. Once a Valid request has been verified, the user's card is debited and a gCheck record is created to document the transaction.

vi. Back end processes and accounting personnel work off of the gCheck records to perform reporting, reconciliations, and audits.

The example above is described in the context of a specific combination of a check authorization/verification service provider (Certegy), a designated retailer (Walmart), and a settlement bank (First Regional Bank). However, the present invention may be implemented with any other check verification providers, retailers or settlement banks.

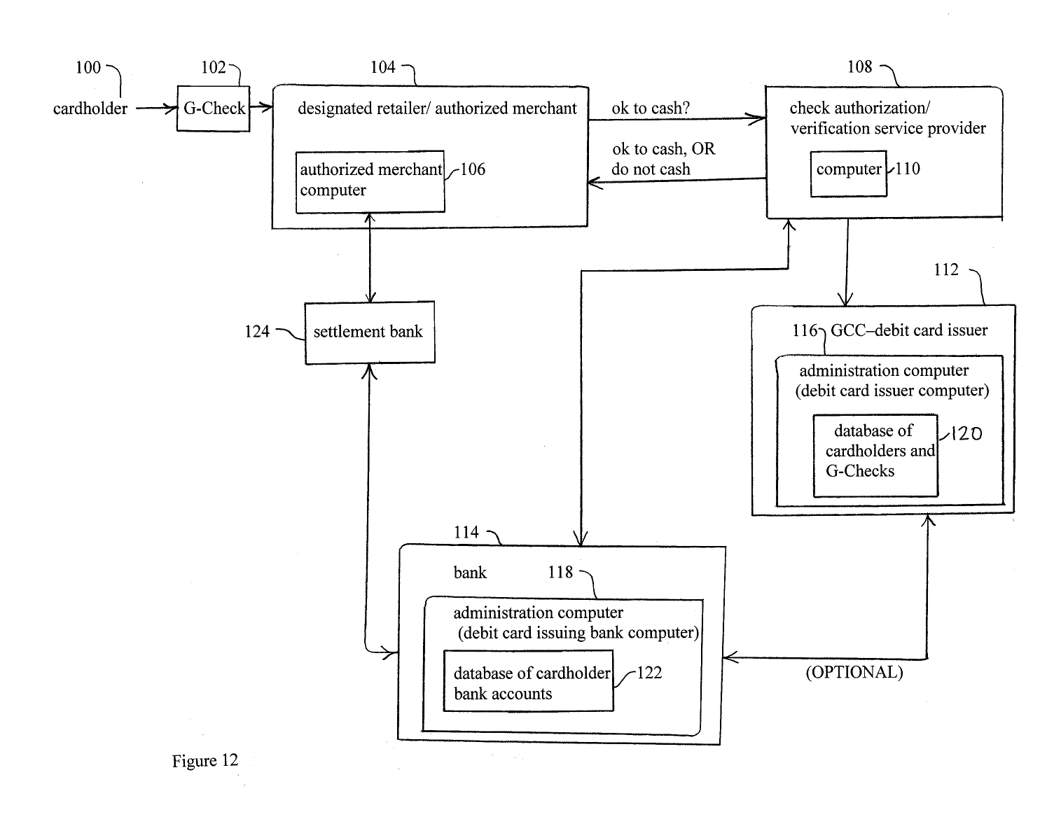

FIG. 12 is a schematic block diagram of the hardware/software components of one preferred embodiment of the present invention which was described above and illustrated in FIGS. 1-11. FIG. 12 shows a cardholder 100 who presents a G-Check 102 to an authorized merchant (designated retailer) 104. The authorized merchant 104 has an authorized merchant computer 106 that electronically communicates with a verification service provider (check authorization entity) 108, and more specifically, with a computer 110 of the verification service provider 108, to request whether it is okay or not okay to cash the presented G-Check 102. The computer 110 (also, referred to as “check authorization computer 110”) of the verification service provider 108 electronically communicates with GCC 112 and/or bank 114, and more specifically, with an administration computer 116 of the GCC 112 (also, referred to as a “debit card issuer computer”) and/or an administration computer 118 of the bank 114 (also, referred to as a “debit card issuing bank computer”), to verify whether the presented G-Check 102 can be cashed. More specifically, a database of cardholders and G-Checks 120 in GCC's administration computer 116 and/or a database of cardholder bank accounts 122 in the bank's administration computer 118 are consulted to verify whether the presented G-Check 102 can be cashed. The verification service provider 108 communicates the decision (“ok to cash” or “do not cash”) to the authorized merchant computer 106, which, in turn, communicates the decision to a clerk via a user interface display screen (not shown). If the G-Check is cashed, a settlement bank 124 settles the transaction between the authorized merchant and the bank 114.

As discussed above, at least four pieces of information must be verified before approving a G-Check 102 that is presented to an authorized merchant 104, namely that:

(i) the debit card bank account number on the G-Check 102 matches a live account,

(ii) the unique serial number on the G-Check 102 is properly associated with an uncashed G-Check that was previously assigned to the debit card bank account number,

(iii) the balance of the debit card bank account is equal to or greater than the amount of desired funds requested in the G-Check 102, and

(iv) one or more personal identification information given to the authorized merchant 104 by the person who presented the G-Check 102 matches the corresponding personal identification information associated with the debit card bank account.

In one preferred arrangement, the verification service provider 108 verifies items (i), (ii) and (iv) at the GCC 112, and verifies item (i) and (iii) at the bank 114. (Item (i) is used by the GCC 112 and the bank 114 to locate the appropriate database records for verification of the other items.)

In another arrangement, the GCC 112 obtains bank account data from the bank's database 122 upon request, and the verification service provider 108 communicates only with the GCC 112 to obtain all four items. In yet another arrangement, the bank 114 obtains data from the GCC's database 120 upon request, and the verification service provider 108 communicates only with the bank 114 to obtain all four items.

One preferred embodiment of the process described above can be summarized as a method of using paper checks to debit funds maintained in a debit card bank account, wherein the debit card bank account has a debit card bank account number and is associated with a person. The method operates as follows:

1. A plurality of unique serial numbers are assigned to be pre-printed on paper checks that are associated with the debit card bank account number. The unique serial numbers have no relationship to any personally identifiable information associated with the person.

2. A plurality of paper checks for the debit card bank account number are provided to the person. Each paper check includes (i) the debit card bank account number, (ii) one of the assigned unique serial numbers, and (iii) a blank check amount area. The unique serial number is preferably visible on the paper check.

3. A database in an administration computer maintains at least (i) the balance of the debit card bank account, (ii) the assigned unique serial numbers, and (iii) one or more personal identification information associated with the person, such as the social security number or a portion of the social security number of the person.

4. The administration computer receives an automated request initiated by a remote computer (e.g., authorized merchant computer) to cash a filled out one of the paper checks. The request includes at least (i) the debit card bank account number, (ii) the unique serial number of the paper check, (iii) an amount of desired funds requested in the check amount area of the paper check, and (iv) one or more personal identification information related to the person presenting the paper check. The debit card bank account number and the unique serial number are preferably both encoded in the MICR of the paper check so that this data can be obtained from the MICR by a conventional check reader.

5. The debit card bank account is electronically debited with the amount of desired funds if the administration computer responds that (i) the balance of the debit card bank account is equal to or greater than the amount of desired funds requested in the check amount area of the paper check, and (ii) the unique serial number of the paper check matches one of the assigned unique serial numbers and is not associated with a previously cashed paper check, and (iii) one or more personal identification information related to the person presenting the paper check matches corresponding personal identification information associated with the debit card bank account.

6. The remote computer (e.g., authorized merchant computer) is informed that the filled out paper check is approved for cashing if the electronic debiting in step 5 successfully occurs.

The references to the “administration computer” and the “database” in this summarized process encompasses any of the arrangements described above. That is, the functionality of the “administration computer” may be performed by any combination of the administration computers 116 and 118 shown in FIG. 12, and the functionality of the “database” may be performed by any combination of the databases 120 and 122 shown in FIG. 12.

Another preferred embodiment of the process described above can be summarized as a method of using paper checks to debit funds maintained in a debit card bank account at a debit card issuing bank, wherein the debit card bank account has a debit card bank account number and is associated with a person. The method operates as follows:

1. A debit card issuer assigns a plurality of unique serial numbers to be pre-printed on paper checks that are associated with the debit card bank account number. The unique serial numbers have no relationship to any personally identifiable information associated with the person;

2. A plurality of paper checks for the debit card bank account number are provided to the person. Each paper check includes (i) the debit card bank account number, (ii) one of the assigned unique serial numbers, and (iii) a blank check amount area.

3. A debit card issuer computer (here, GCC) maintains a first database that includes (i) the debit card bank account number, (ii) the assigned unique serial numbers, and (iii) one or more personal identification information associated with the person.

4. The computer of the debit card issuing bank maintains a second database that includes (i) the debit card bank account number, and (ii) the balance of the debit card bank account.

5. A check authorization computer receives an automated request initiated by a remote computer (here, the authorized merchant computer) to cash a filled out one of the paper checks. The request includes (i) the debit card bank account number, (ii) the unique serial number of the paper check, (iii) an amount of desired funds requested in the check amount area of the paper check, and (iv) one or more personal identification information related to the person presenting the paper check.

6. The check authorization computer electronically communicates the information received in the request to the check authorization computer and to the debit card issuer computer, and receives back information related to the request resulting from a comparison of the request with the information in the first database of the debit card issuer computer and the information in the second database of the debit card issuing bank computer.

7. The debit card bank account is electronically debited with the amount of desired funds if the (i) the balance of the debit card bank account is equal to or greater than the amount of desired funds requested in the check amount area of the paper check, and (ii) the unique serial number of the paper check matches one of the assigned unique serial numbers and is not associated with a previously cashed paper check, and (iii) one or more personal identification information related to the person presenting the paper check matches corresponding personal identification information associated with the debit card bank account.

8. The remote computer (e.g., authorized merchant computer) is informed that the filled out paper check is approved for cashing if the electronic debiting in step 7 successfully occurs.

As described in this preferred embodiment, the entity that assigns the unique serial numbers (here, GCC) is not the same entity as the bank (debit card issuing bank), nor is it the same entity as the person. Furthermore, the unique serial number is compared against a database maintained by the same entity that issued the unique serial numbers, namely, GCC's database 120, not a database maintained by a different entity, such as the bank.

The pre-printed paper checks, as shown in FIG. 3, preferably have no payee, date or authorized signature. This data is filled in upon presenting of the paper check to the authorized merchant. The payee may be the authorized merchant, an entity designated by the merchant, or the payee may be “CASH.”

In the preferred embodiment, the concept of “unique serial numbers” means that at any one time, there are no duplicate serial numbers issued for uncashed checks for a particular debit card account. That is, if a previously printed G-Check is cashed, the serial number of that G-Check may be reused on another G-Check for that particular debit card account. In an alternative embodiment, no previously issued serial numbers may be reused for a particular debit card account. The same serial numbers may be used on different debit card accounts.

The unique serial numbers used in the present invention differ from check numbers placed on conventional checking accounts in a number of ways.

First, a check number in a conventional checking account is primarily used for customer identification purposes, not for validating a check. Typically, the check number (if one exists) is captured during the check clearing process and provided on a customer's statement to assist the customer in reconciling cleared checks. A customer's bank may not even know what all of the check numbers of blank checks that the customer has in their possession, especially because many checks are printed by third party vendors that are not affiliated with the customer's bank.

Second, there is no requirement that check numbers in a conventional checking account be unique. For example, a customer may request a new set of checks that begins with the same or overlapping check numbers as previously issued sets of checks. It may thus be possible for a customer to have the same check number assigned to more than one uncashed check.

As discussed above, Global Cash Card (GCC) is a Prepaid Card Issuer, and more specifically, a prepaid debit card issuer. Prepaid debit cards are reloadable cards that allow you to only spend up to the amount you have pre-deposited into a bank account associated with the card. The prepaid card issued by GCC are reloaded by adding funds to the bank account. GCC is not a bank. However, the scope of the present invention includes an embodiment wherein a banking entity is both the debit card issuer 112 and the debit card issuing bank 114. The scope of the present invention also includes an embodiment wherein a non-banking entity other than a prepaid card issuer is a debit card issuer 112 that works in conjunction with a debit card issuing bank 114.

The GCC process may be implemented on a host server (computer) that is in electronic communication with the various entities that it must interact with via an electronic network, such as the Internet or a LAN. The computers used by the designated retailers, check authorization/verification service provider, and settlement bank may likewise communicate via the electronic network.

The present invention may be implemented with any combination of hardware and software. If implemented as a computer-implemented apparatus, the present invention is implemented using means for performing all of the steps and functions described above.

When implemented in software, the software code can be executed on any suitable processor or collection of processors, whether provided in a single computer or distributed among multiple computers.

The present invention can also be included in an article of manufacture (e.g., one or more computer program products) having, for instance, computer readable storage media. The storage media has computer readable program code stored therein that is encoded with instructions for execution by a processor for providing and facilitating the mechanisms of the present invention. The article of manufacture can be included as part of a computer system or sold separately.

The storage media can be any known media, such as computer memory, one or more floppy discs, compact discs, optical discs, magnetic tapes, flash memories, circuit configurations in Field Programmable Gate Arrays or other semiconductor devices, or other tangible computer storage medium. The storage media can be transportable, such that the program or programs stored thereon can be loaded onto one or more different computers or other processors to implement various aspects of the present invention as discussed above.

The computers used herein may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable, mobile, or fixed electronic device.

The computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

The terms “program” or “software” are used herein in a generic sense to refer to any type of computer code or set of computer-executable instructions that can be employed to program a computer or other processor to implement various aspects of the present invention as discussed above. The computer program need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, and the like, that perform particular tasks or implement particular abstract data types. The functionality of the program modules may be combined or distributed as desired in various embodiments.

Data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Preferred embodiments of the present invention may be implemented as methods, of which examples have been provided. The acts performed as part of the methods may be ordered in any suitable way. Accordingly, embodiments may be constructed in which acts are performed in an order different than illustrated, which may include performing some acts simultaneously, even though such acts are shown as being sequentially performed in illustrative embodiments.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

What is claimed is:

1. A method of using paper checks to debit funds maintained in a debit card bank account, the debit card bank account having a debit card bank account number and being associated with a person, the method comprising;
(a) assigning a plurality of unique serial numbers to be pre-printed on paper checks that are associated with the debit card bank account number, wherein the unique serial numbers have no relationship to any personally identifiable information associated with the person;
(b) providing a plurality of paper checks for the debit card bank account number to the person, each paper check including:
(i) the debit card bank account number,
(ii) one of the assigned unique serial numbers, and
(iii) a blank check amount area;
(c) maintaining, in an administration computer, a database that includes:
(i) the debit card bank account number,
(ii) the account balance of the debit card bank account,
(iii) the assigned unique serial numbers, and
(iv) one or more personal identification information associated with the person;
(d) receiving, at the administration computer, an automated request initiated by a remote computer to cash a filled out one of the paper checks, the request including:
(i) the debit card bank account number,
(ii) the unique serial number of the paper check,
(iii) an amount of desired funds requested in the check amount area of the paper check, and
(iv) one or more personal identification information related to the person presenting the paper check; and
(e) electronically debiting the debit card bank account with the amount of desired funds if the administration computer responds that:
(i) the account balance of the debit card bank account is equal to or greater than the amount of desired funds requested in the check amount area of the paper check, and
(ii) the unique serial number of the paper check matches one of the assigned unique serial numbers and is not associated with a previously cashed paper check, and
(iii) one or more personal identification information related to the person presenting the paper check matches corresponding personal identification information associated with the debit card bank account.

2. The method of claim 1 wherein the automated request initiated by the remote computer is initiated by an authorized merchant computer.

3. The method of claim 2 further comprising:
(f) electronically communicating to the authorized merchant computer that the filled out one of the paper checks is approved for cashing if the electronic debiting in step (e) successfully occurs.

4. The method of claim 1 wherein the personal identification information is the social security number or a portion of the social security number of the person.

5. The method of claim 1 wherein the debit card bank account number and the unique serial number are both encoded in the MICR of the paper check, the debit card bank account number and the unique serial number being obtained in step (d) from the MICR.

6. The method of claim 1 wherein the unique serial number is visible on the paper check.

7. The method of claim 1 wherein step (a) is performed by a debit card issuer computer.

8. A method of using paper checks to debit funds maintained in a debit card bank account at a debit card issuing bank, the debit card bank account having a debit card bank account number and being associated with a person, the method comprising;
(a) assigning, by a debit card issuer computer, a plurality of unique serial numbers to be pre-printed on paper checks that are associated with the debit card bank account number, wherein the unique serial numbers have no relationship to any personally identifiable information associated with the person;
(b) providing a plurality of paper checks for the debit card bank account number to the person, each paper check including:
(i) the debit card bank account number,
(ii) one of the assigned unique serial numbers, and
(iii) a blank check amount area;
(c) maintaining, in the debit card issuer computer, a first database that includes:
(i) the debit card bank account number,
(ii) the assigned unique serial numbers, and
(iii) one or more personal identification information associated with the person;
(d) maintaining, in a computer of the debit card issuing bank, a second database that includes:
(i) the debit card bank account number, and
(ii) the account balance of the debit card bank account,
(e) receiving, at a check authorization computer, an automated request initiated by a remote computer to cash a filled out one of the paper checks, the request including:
(i) the debit card bank account number,
(ii) the unique serial number of the paper check,
(iii) an amount of desired funds requested in the check amount area of the paper check, and
(iv) one or more personal identification information related to the person presenting the paper check;
(f) electronically communicating the information received in the request from the check authorization computer to the debit card issuer computer and to the debit card issuing bank computer, and receiving back information related to the request resulting from a comparison of the request with the information in the first database of the debit card issuer computer and the information in the second database of the debit card issuing bank computer; and
(g) electronically debiting the debit card bank account with the amount of desired funds if:
(i) the balance of the debit card bank account is equal to or greater than the amount of desired funds requested in the check amount area of the paper check, and
(ii) the unique serial number of the paper check matches one of the assigned unique serial numbers and is not associated with a previously cashed paper check, and
(iii) one or more personal identification information related to the person presenting the paper check matches corresponding personal identification information associated with the debit card bank account.

9. The method of claim 8 wherein the automated request initiated by the remote computer is initiated by an authorized merchant computer.

10. The method of claim 9 further comprising:
(h) electronically communicating to the authorized merchant computer that the filled out one of the paper checks is approved for cashing if the electronic debiting in step (g) successfully occurs.

11. The method of claim 8 wherein the personal identification information is the social security number or a portion of the social security number of the person.

12. The method of claim 8 wherein the debit card bank account number and the unique serial number are both encoded in the MICR of the paper check, the debit card bank account number and the unique serial number being obtained in step (e) from the MICR.

13. The method of claim 8 wherein the unique serial number is visible on the paper check.

14. The method of claim 8 wherein the debit card issuer computer is associated with a prepaid card issuer.

15. A method of using paper checks to debit funds maintained in debit card bank accounts, each debit card bank account having a debit card bank account number and being associated with a person, the method comprising;
(a) assigning for each debit card bank account a plurality of unique serial numbers to be pre-printed on paper checks that are associated with the debit card bank account number, wherein the unique serial numbers have no relationship to any personally identifiable information associated with the person;
(b) providing a plurality of paper checks for each debit card bank account number to the respective persons, each paper check including:
(i) the debit card bank account number,
(ii) one of the assigned unique serial numbers, and
(iii) a blank check amount area;
(c) maintaining, in an administration computer, a database that includes for each debit card bank account:
(i) the debit card bank account number,
(ii) the account balance of the debit card bank account,
(iii) the assigned unique serial numbers, and
(iv) one or more personal identification information associated with the person;
(d) receiving, at the administration computer, an automated request initiated by a remote computer to cash a filled out one of the paper checks, the request including:
(i) the debit card bank account number,
(ii) the unique serial number of the paper check,
(iii) an amount of desired funds requested in the check amount area of the paper check, and
(iv) one or more personal identification information related to the person presenting the paper check; and
(e) electronically debiting the debit card bank account associated with the filled out check with the amount of desired funds if the administration computer responds that:
(i) the account balance of the debit card bank account is equal to or greater than the amount of desired funds requested in the check amount area of the paper check, and
(ii) the unique serial number of the paper check matches one of the assigned unique serial numbers and is not associated with a previously cashed paper check, and
(iii) one or more personal identification information related to the person presenting the paper check matches corresponding personal identification information associated with the debit card bank account.

16. The method of claim 15 wherein the automated request initiated by the remote computer is initiated by an authorized merchant computer.

17. The method of claim 16 further comprising:
(f) electronically communicating to the authorized merchant computer that the filled out one of the paper checks is approved for cashing if the electronic debiting in step (e) successfully occurs.

18. The method of claim 15 wherein the personal identification information is the social security number or a portion of the social security number of the person.

19. The method of claim 15 wherein the debit card bank account number and the unique serial number are both encoded in the MICR of the paper check, the debit card bank account number and the unique serial number being obtained in step (d) from the MICR.

20. The method of claim 15 wherein the unique serial number is visible on the paper check.

21. The method of claim 15 wherein step (a) is performed by a debit card issuer computer.

22. A method of using paper checks to debit funds maintained in debit card bank accounts at a debit card issuing bank, each debit card bank account having a debit card bank account number and being associated with a person, the method comprising;
(a) assigning for each debit card bank account, by a debit card issuer computer, a plurality of unique serial numbers to be pre-printed on paper checks that are associated with the debit card bank account number, wherein the unique serial numbers have no relationship to any personally identifiable information associated with the person;
(b) providing a plurality of paper checks for each debit card bank account number to the respective persons, each paper check including:
(i) the debit card bank account number,
(ii) one of the assigned unique serial numbers, and
(iii) a blank check amount area;
(c) maintaining, in the debit card issuer computer, a first database that includes for each debit card bank account:
(i) the debit card bank account number,
(ii) the assigned unique serial numbers, and
(iii) one or more personal identification information associated with the person;
(d) maintaining, in a computer of the debit card issuing bank, a second database that includes for each debit card bank account:
(i) the debit card bank account number, and
(ii) the account balance of the debit card bank account,
(e) receiving, at a check authorization computer, an automated request initiated by a remote computer to cash a filled out one of the paper checks, the request including:
(i) the debit card bank account number,
(ii) the unique serial number of the paper check,
(iii) an amount of desired funds requested in the check amount area of the paper check, and
(iv) one or more personal identification information related to the person presenting the paper check;
(f) electronically communicating the information received in the request from the check authorization computer to the debit card issuer computer and to the debit card issuing bank computer, and receiving back information related to the request resulting from a comparison of the request with the information in the first database of the debit card issuer computer and the information in the second database of the debit card issuing bank computer; and
(g) electronically debiting the debit card bank account associated with the filled out check with the amount of desired funds if:
(i) the balance of the debit card bank account is equal to or greater than the amount of desired funds requested in the check amount area of the paper check, and
(ii) the unique serial number of the paper check matches one of the assigned unique serial numbers and is not associated with a previously cashed paper check, and
(iii) one or more personal identification information related to the person presenting the paper check matches corresponding personal identification information associated with the debit card bank account.

23. The method of claim 22 wherein the automated request initiated by the remote computer is initiated by an authorized merchant computer.

24. The method of claim 23 further comprising:
(h) electronically communicating to the authorized merchant computer that the filled out one of the paper checks is approved for cashing if the electronic debiting in step (g) successfully occurs.

25. The method of claim 22 wherein the personal identification information is the social security number or a portion of the social security number of the person.

26. The method of claim 22 wherein the debit card bank account number and the unique serial number are both encoded in the MICR of the paper check, the debit card bank account number and the unique serial number being obtained in step (e) from the MICR.

27. The method of claim 22 wherein the unique serial number is visible on the paper check.

28. The method of claim 22 wherein the debit card issuer computer is associated with a prepaid card issuer.
